(19) United States
(12) Patent Application Publication
(10) Pub. No.: US 2009/0036619 A1
(43) Pub. Date: Feb. 5, 2009

(54) Highly crystalline polypropylene waxes

(75) Inventors: Hans-Friedrich Herrmann, Sulzbach (DE); Gerald Mehltretter, Sulzbach (DE); Hans Rausch, Sulzbach (DE); Gerd Hohner, Sulzbach (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/221,234

(22) Filed: Jul. 31, 2008

(30) Foreign Application Priority Data
Aug. 3, 2007 (DE) 10 2007 036 792.0

(51) Int. Cl. C08F 4/642; C08F 110/06; C08F 4/16; C08F 4/52; C08F 4/18; C08F 4/64

(52) U.S. Cl. 526/127; 526/351; 526/170; 526/90; 526/160

(57) ABSTRACT

Polypropylene wax having
a) a dropping or softening point determined by the ring/ball method of greater than 155° C.,
b) heats of fusion greater than 80 J/g and
c) a DSC melting point of >155° C.

The waxes of the invention are prepared by reaction of propylene with metallocene compounds at temperatures in the range from 40 to 140° C. and an olefin partial pressure in the range from 1 to 50 bar in the presence of a cocatalyst. They have a content of unsaturated chain ends of less than 10%. They can, for example, be modified by means of a free-radical grafting reaction with polar monomers and are, for example, suitable in unmodified form as dispersants for pigments, as additive in printing inks and surface coatings or toners or in modified form for producing aqueous dispersions or as bonding agents and compatibilizers in plastic compounds.

The present invention is described in the German priority application No. 10 2007 036 792.0, filed Aug. 3, 2007, which is hereby incorporated by reference as is fully disclosed herein.

The present invention relates to polypropylene waxes having a high melting point and a high crystallinity and also the use of such waxes.

For the present purposes, polypropylene waxes are materials which have low average degrees of polymerization or chain lengths compared to plastic-like polypropylene. These characteristics in turn result in low melt viscosities which in the case of the waxes are, when measured at 170° C., typically in the range from about 20 to 30 000 mPa·s, while in the case of polypropylene plastics they are generally above 100 000 mPa·s. The physical properties of polypropylene waxes (PP waxes) are significantly different from those of polypropylene plastics. The fields of use are accordingly also different.

Polypropylene waxes are used industrially in many ways, e.g. as dispersants for pigments for coloring thermoplastic polymers, as auxiliaries in plastics processing, as matting and abrasion protection additive in printing inks and surface coatings, as constituent of photo toner compositions and in formulations for hot melt compositions. Many of these applications require high degrees of crystallinity and high melting points. For example, the heat resistance of hot melt compositions can be increased by use of PP waxes having a high melting point. As matting and abrasion protection agents in printing inks and surface coatings, the waxes are used in milled, frequently also micronized, form. High degrees of crystallinity are advantageous here since these are associated with product hardnessess which aids the milling process or is necessary to make the desired small particle size possible at all. In addition, high hardnesses produce an improved abrasion protection action. The heat of fusion measured by the DSC (differential scanning calorimetry) method or the isotacticity which can be determined by means of infrared spectroscopy can be employed as measure of the degree of crystallinity.

Polypropylene waxes can be prepared, inter alia, by processes which are in principle similar to those for high molecular weight polypropylene plastics, namely by direct polymerization of propylene, if appropriate with addition of other olefins as comonomers, using appropriate catalysts. However, the polymerization conditions and thus the requirements which catalysts and processes have to meet are naturally significantly different in each case since the degree of polymerization sought is different in each case. Possible catalysts are, for example, those of the Ziegler-Natta type or more recently also of the metallocene type.

For example, DE 3 148 229 describes the preparation of PP waxes with the aid of modified Ziegler-Natta catalysts. Although dropping points up to a maximum of 158-160° C. are reported, the heats of fusion are not above 63 J/g. The maximum catalyst yield achieved is 429 g of wax/mmol of titanium, i.e. the amount of catalyst to be used is comparatively high, which makes complicated decomposition and removal of the catalyst necessary.

EP 321852 describes the preparation of poly-alpha-olefin waxes using metallocene catalysts. Waxes having dropping points in the range from 120 to 160° C. are claimed, and the waxes disclosed in the examples have dropping points in the range from 139 to 144° C.

EP 890584 describes polypropylene waxes which are prepared by means of metallocene catalysts and have isotacticities of over 70% and heats of fusion of more than 80 J/g. The melting points determined by the DSC method are, according to the information given in the examples, in the range from 122 to 155° C. The dropping or softening points are not reported.

WO 2006/053757 describes a process for preparing, inter alia, polypropylene having a molar mass Mw in the range from 500 to 50 000 g/mol by means of specific metallocene catalysts. The polypropylenes mentioned in the examples have average molar masses Mw in the range from 51 000 to 496 000 g/mol and melting points in the range from 151 to 153° C.

No PP waxes obtained by direct polymerization and having dropping or softening points above 160° C. and DSC melting points above 155° C. have hitherto been reported.

Furthermore, it is known, for example from U.S. Pat. No. 2,835,659, that polypropylene waxes can be obtained by thermal degradation of polypropylene plastic at temperatures above 300° C. When appropriate raw materials are used, highly crystalline waxes having a high melting point can be obtained, but these have thermal and oxidative damage due to the high temperatures and long residence times required for the degradation process. This damage results, for instance, in undesirable yellowing and disadvantageous odor properties. The degraded chain molecules contain, as a result of the reaction mechanism, about 50% of olefinic double bonds which, owing to their reactivity, have an adverse effect on the chemical and thermal stability of the waxes.

It was therefore an object of the invention to provide polypropylene waxes which simultaneously have a high dropping or softening point, high crystallinity, high hardness, a low content of olefinic double bonds, light color and good thermal stability.

It has now surprisingly been found that high-melting, highly crystalline and at the same time thermally stable PP waxes can be obtained in high catalyst yields by direct polymerization of propylene, in particular using metallocene catalysts.

The invention provides polypropylene waxes having
a) a dropping or softening point determined by the ring/ball method of greater than 155° C., in particular >160° C.;
b) heats of fusion greater than 80 J/g and
c) a DSC melting point of >155° C.

The content of unsaturated chain ends is below 10%.

The molar mass distribution Mw/Mn of the waxes of the invention is preferably in the range from 1.5 to 3.0. Furthermore, they have a viscosity, measured in the melt at 170° C., in the range from 20 to 30 000 mPa·s.

Preference is given to polypropylene waxes having dropping or softening points of greater than 160° C., particularly preferably greater than 162° C. The DSC melting points are preferably greater than 157° C., particularly preferably greater than 158° C. Preferred heats of fusion are above 90 J/g, particularly preferably above 100 J/g. Preference is given to polypropylene waxes having a content of unsaturated chain ends of less than 5%, a molar mass distribution Mw/Mn in the range from 1.8 to 2.5 and a viscosity, measured in the melt at 170° C., in the range from 50 to 20 000 mPa·s.

The polyolefin waxes used according to the invention are prepared using metallocene compounds of the formula I.

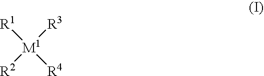

This formula also encompasses compounds of the formula Ia,

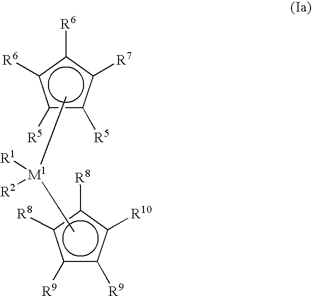

of the formula Ib

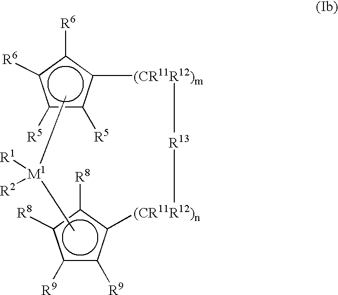

and of the formula Ic

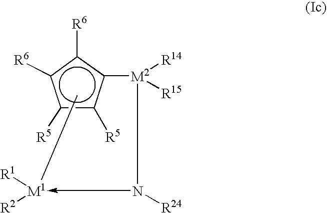

In the formulae I, Ia and Ib, M¹ is a metal of group 4, 5 or 6 of the Periodic Table, for example titanium, zirconium, hafnium, vanadium, niobium, tantalum, chromium, molybdenum, tungsten, preferably titanium, zirconium, hafnium.

R¹ and R² are identical or different and are each a hydrogen atom, a C₁₋C₁₀—, preferably C₁-C₃-alkyl group, in particular methyl, a C₁-C₁₀—, preferably C₁-C₃-alkoxy group, a C₆-C₁₀—, preferably C₆-C₈-aryl group, a C₆-C₁₀—, preferably C₆-C₈-aryloxy group, a C₂-C₁₀—, preferably C₂-C₄-alkenyl group, a C₇-C₄₀—, preferably C₇-C₁₀-arylalkyl group, a C₇-C₄₀—, preferably C₇-C₁₂-alkylaryl group, a C₈-C₄₀—, preferably C₈-C₁₂-arylalkenyl group or a halogen atom, preferably a chlorine atom.

R³ and R⁴ are identical or different and are each a monocyclic or polycyclic hydrocarbon radical which may contain heteroatoms from groups 13, 15 or 16 of the Periodic Table and can together with the central atom M¹ form a sandwich structure. R³ and R⁴ are preferably cyclopentadienyl, indenyl, tetrahydroindenyl, benzoindenyl, fluorenyl, thiaphenyl, thiapentalenyl, cyclopentadithiaphenyl or azapentalenyl, where the parent molecules may bear additional substituents or be linked to one another. In addition, one of the radicals R³ and R⁴ can be a substituted nitrogen atom, where R²⁴ has the meaning of R¹⁷ and is preferably methyl, tert-butyl or cyclohexyl.

R⁵, R⁶, R⁷, R⁸, R⁹ and R¹⁰ are identical or different and are each a hydrogen atom, a halogen atom, preferably a fluorine, chlorine or bromine atom, a C₁-C₁₀—, preferably C₁-C₄-alkyl group, a C₆-C₁₀—, preferably C₆-C₈-aryl group, a C₁-C₁₀—, preferably C₁-C₃-alkoxy group, an —NR¹⁶₂, —SR¹⁶, —OSiR¹⁶₃, —SiR¹⁶₃ or —PR¹⁶₂ radical, where R¹⁶ is a C₁₋C₁₀—, preferably C₁-C₃-alkyl group or C₆-C₁₀—, preferably C₆-C₈-aryl group or in the case of Si— or P-containing radicals may also be a halogen atom, preferably a chlorine atom, or two adjacent radicals R⁵, R⁶, R⁷, R⁸, R⁹ or R¹⁰ together with the carbon atoms connecting them form a ring. Particularly preferred ligands are the substituted compounds of the parent molecules cyclopentadienyl, indenyl, tetrahydroindenyl, benzindenyl or fluorenyl.

R¹³ is

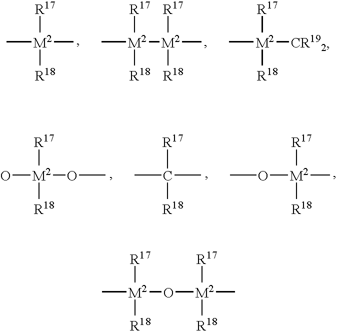

═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸ and R¹⁹ are identical or different and are each a hydrogen atom, a halogen atom, preferably a fluorine, chlorine or bromine atom, a C₁-C₃₀—, preferably C₁-C₄-alkyl group, in particular a methyl group, a C₁-C₁₀-fluoroalkyl, preferably CF₃, group, a C₆-C₁₀-fluoroaryl, preferably pentafluorophenyl, group, a C₆-C₁₀—, preferably C₆-C₈-aryl group, a C₁-C₁₀—, preferably C₁-C₄-alkoxy group, in particular a methoxy group, a C₂-C₁₀—, preferably C₂-C₄-alkenyl group, a C₇-C₄₀—, preferably C₇-C₁₀-aralkyl group, a C₈-C₄₀—, preferably C₈-C₁₂-arylalkenyl group or a C₇-C₄₀, preferably C₇-C₁₂-alkylaryl group or R¹⁷ and R¹⁸ or R¹⁷ and R¹⁹ in each case together with the atoms connecting them form a ring.

M² is silicon, germanium or tin, preferably silicon or germanium. R¹³ is preferably ═CR¹⁷R¹⁸, ═SiR¹⁷R¹⁸, ═GeR¹⁷R¹⁸, —O—, —S—, ═SO, ═PR¹⁷ or ═P(O)R¹⁷.

R¹¹ and R¹² are identical or different and have the meanings given for R¹⁷. m and n are identical or different and are each zero, 1 or 2, preferably zero or 1, where m plus n is zero, 1 or 2, preferably zero or 1.

R¹⁴ and R¹⁵ have the meanings of R¹⁷ and R¹⁸.

Preference is given to using metallocene compounds of the formula 2,

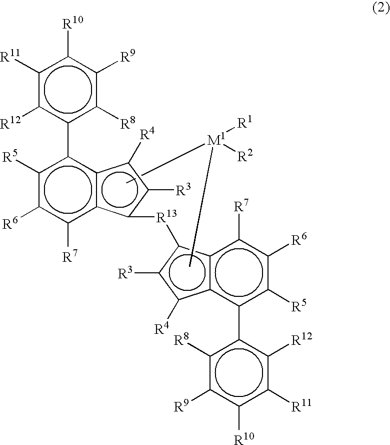

In the formula 2, M¹ is a metal of group 4, 5 or 6 of the Periodic Table, for example titanium, zirconium, hafnium, vanadium, niobium, tantalum, chromium, molybdenum, tungsten, preferably titanium, zirconium, hafnium.

R¹ and R² have the same meanings as in formula 1.

The radicals R³ to R¹² are identical or different and are each a hydrogen atom, a halogen atom, preferably fluorine, chlorine, or bromine, a C₁-C₁₀—, preferably C₁-C₄-alkyl group which may be halogenated, a C₆-C₁₀—, preferably C₆-C₈-aryl group, an —NR¹⁶₂—, —SR¹⁶—, —SiR¹⁶₃— or PR¹⁶₂— radical, where R¹⁶ is a halogen atom, preferably chlorine, a C₁-C₁₀—, preferably C₁-C₄-alkyl group or a C₆-C₁₀—, preferably C₆-C₈-aryl group.

The adjacent radicals R⁴ to R¹² together with the atoms connecting them can form an aromatic, preferably 6-membered ring or an aliphatic, preferably 4-8-membered ring.

R¹³ has the same meaning as in formula 1b.

Preference is also given to using metallocenes of the formula 3:

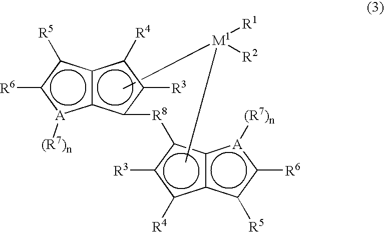

In the formula 3, M¹ is a metal of group 4, 5 or 6 of the Periodic Table, for example titanium, zirconium, hafnium, vanadium, niobium, tantalum, chromium, molybdenum, tungsten, preferably titanium, zirconium, hafnium.

A is an element of group 14, 15 or 16 of the Periodic Table, preferably sulfur or nitrogen.

n is 0, 1 or 2, with the proviso that n is 0 when A is an element of group 16 of the Periodic Table, n is 1 when A is an element of group 15 of the Periodic Table and n is 1 or 2 when A is an element of group 14 of the Periodic Table.

R¹ and R² have the same meanings as in the formulae 1 and 2.

The radicals R³ to R⁷ are identical or different and are each a hydrogen atom, a halogen atom, preferably fluorine, chlorine or bromine, a C₁-C₁₀—, preferably C₁-C₄-alkyl group which may be halogenated, a C₆-C₁₀—, preferably C₆-C₈-aryl group, a C₇-C₁₀ alkylaryl group or a C₇-C₁₀ arylalkyl group.

The radical R⁸ has the same meanings as the radical R¹³ in the formulae 1b and 2.

Very particular preference is given to using the following metallocenes:

Dimethylsilanediylbis(2-methyl-4-phenylindenyl)zirconium dichloride

Ethanediylbis(2-methyl-4-phenylindenyl)zirconium dichloride

Dimethylsilanediylbis(2-methyl-4-naphthylindenyl)zirconium dichloride

Dimethylsilanediylbis-6-[2,5-dimethyl-3-(2′-methylphenyl)cyclopentadienyl[1,2-b]thiophene]zirconium dichloride and in each case the alkyl or aryl derivatives of these metallocene dichlorides.

To activate the single-site catalyst systems, suitable cocatalysts are used. Suitable cocatalysts for metallocenes of the formula I are organoaluminum compounds, in particular aluminoxanes, or aluminum-free systems such as R²⁰ₓNH₄₋ₓBR²¹₄, R²⁰ₓPH₄₋ₓBR²¹₄, R²⁰₃CBR²¹₄ or BR²¹₃. In these formulae, x is from 1 to 4, the radicals R²⁰ are identical or different, preferably identical, and are each C₁-C₁₀-alkyl or C₆-C₁₈-aryl or two radicals R²⁰ together with the atom connecting them form a ring and the radicals R²¹ are identical or different, preferably identical, and are each C₆-C₁₈-aryl which may be substituted by alkyl, haloalkyl or fluorine. In particular, R²⁰ is ethyl, propyl, butyl or phenyl and R²¹ is phenyl, pentafluorophenyl, 3,5-bis-trifluoromethylphenyl, mesityl, xylyl or tolyl.

In addition, a third component is frequently necessary to maintain protection against polar catalyst poisons. Organoaluminum compounds such as triethylaluminum, tributylaluminum and others and also mixtures are suitable for this purpose.

Depending on the process, it is also possible to use supported single-site catalysts. Preference is given to using catalyst systems in which the residual contents of support material and cocatalysts do not exceed a concentration of 100 ppm in the product.

The catalyst can be introduced as a solution, suspension or dry in supported form. Suitable solvents or suspension media for catalyst or cocatalyst are hydrocarbons in general, e.g. hexane, cyclohexane, heptane, octane, industrial diesel oils, toluene, xylene.

The polymerization can be carried out in solution, in suspension or in the gas phase at temperatures in the range from 40 to 140° C., at an olefin partial pressure in the range from 1 to 50 bar, at a hydrogen partial pressure in the range from 0 to 10 bar, with addition of (based on aluminum) from 0.01 to 10 mmol of cocatalyst/liter of suspension medium or solvent and a catalyst/cocatalyst ratio of from 1:1 to 1:1.000. The polymerization can be carried out with addition of a further organoaluminum compound such as trimethylaluminum, triethylaluminum, triisobutylaluminum or isoprenylaluminum in a concentration of from 1 to 0.001 mmol of aluminum/l of reactor volume in order to make the system inert.

The polymerization can be carried out batchwise or continuously and in one or more stages.

The molar mass and thus the melt viscosity of the waxes of the invention can be regulated in a known manner by means of hydrogen and/or via the polymerization temperature. Increased hydrogen concentrations or increased polymerization temperatures generally lead to lower molar masses.

The waxes of the invention can be chemically modified by introduction of polar, for example oxygen-containing, functions. Modification is carried out in a known manner, for example by means of a free-radical grafting reaction with polar monomers, for example α,β-unsaturated carboxylic acids or their derivatives, e.g. acrylic acid, maleic acid or maleic anhydride, or unsaturated organosilane compounds such as alkoxyvinylsilanes. Processes for grafting polypropylene waxes are described, for example, in EP 0 941 257 or EP 1 508 579.

The waxes of the invention can, if appropriate after polar modification, be used, for example, as dispersants for pigments for coloring thermoplastic polymers, as lubricants or mold release agents in plastics processing, as matting and abrasion protection additive in printing inks and surface coatings and as constituent of photo toner compositions, and also, preferably in polar modified form, for the production of stable aqueous dispersions. The waxes according to the invention which have been modified with polar functions are particularly suitable for use as bonding agents and compatibilizers in blends or compounds of thermoplastic polymers, for example polyolefins such as polypropylene, with inorganic or organic fillers or reinforcing materials such as glass fibers, calcium carbonate, aluminum silicates, silicon dioxide, magnesium silicates (talc), barium sulfate, aluminum-potassium-sodium silicates, metals or metal oxides such as aluminum or aluminum oxides or hydroxides, carbon black, graphite, wood flour and ground cork and also natural fibers such as flax or hemp.

Owing to, inter alia, their high melting points, the waxes of the invention are particularly suitable as formulation constituents for hot melt compositions with the advantage of high heat resistances, for example for use as hot melt adhesive or for road marking.

The waxes can be processed by spraying or milling to give powders and can also be used in this form if this is necessary or advantageous in the intended use. Owing to their high hardness and brittleness, they are particularly suitable for milling, for example in jet mills or mechanical mills. The finenesses can be set within a wide range; d50 values down to <8 μm can be obtained. The waxes can be comminuted and employed both in pure form and in admixture with waxes of another type, e.g. amide waxes, nonpolar or polar polyolefin waxes not based on metallocenes, montan or Carnauba waxes, paraffins such as Fischer-Tropsch paraffins or further components such as PTFE (polytetrafluoroethylene).

### EXAMPLES

The melt viscosities were determined in accordance with DIN 53019 using a rotational viscometer, the dropping points were determined in accordance with DIN 51801/2 and the ring/ball softening points were determined in accordance with DIN EN 1427. DSC melting points and heats of fusion were determined in accordance with DIN 51700. The second heating curve was evaluated in each case, and the heating and cooling rate was in each case 10° C./min.

The examination of the chain ends of the polymers was carried out by means of 13C-NMR spectroscopy as described in Polymer, 1989, vol. 30, p. 428. If less than 10% of all end groups were unsaturated, this is reported in the examples as “saturated”.

### Example 1

A dry 120 l vessel was flushed with nitrogen, pressurized with 2.4 bar of hydrogen, charged with 40 l of propylene and brought to a temperature of 70° C. In parallel thereto, 10 mg of rac-dimethylsilanediylbis(2-methyl-4-phenylindenyl)zirconium dichloride were dissolved in 30 ml of methylaluminoxane solution in toluene (5% by weight of Al) and preactivated by being left to stand for 15 minutes. The catalyst solution was diluted with 170 ml of toluene and then introduced into the vessel over a period of 30 minutes. After the addition was complete, the mixture was stirred for another 30 minutes. During the entire reaction time, the temperature was maintained at 70° C. by cooling. The pressure was kept constant by introduction of further propylene, and the hydrogen concentration was likewise kept constant by further introduction of hydrogen. After the additional stirring time had elapsed, the reaction was stopped by addition of carbon dioxide.

This gave 9.3 kg of polypropylene wax, corresponding to a catalyst activity of 590 kg of PP wax/mmol of zirconium/hour.

| | |
|---|---|
| Dropping point/softening point (ring/ball): | 162° C. |
| Melting point (DSC) | 158° C. |
| Heat of fusion (DSC) ΔH | 125 J/g |
| Melt viscosity (170° C.) | 543 mPas. |
| No unsaturated chain ends. | |

### Example 2

The procedure of example 1 was repeated with the vessel being pressurized with only 1.0 bar of hydrogen.

This gave 2.1 kg of polypropylene wax, corresponding to a catalyst activity of 130 kg of PP wax/mmol of zirconium/hour.

| | |
|---|---|
| Dropping point/softening point (ring/ball): | 167° C. |
| Melting point (DSC) | 158° C. |
| Heat of fusion (DSC) ΔH | 127 J/g |
| Melt viscosity (170° C.) | 9,560 mPas. |
| No unsaturated chain ends. | |

### Example 3

The procedure of example 1 was repeated but the vessel was pressurized with 0.2 bar of hydrogen and then charged with 40 l of Exxsol and 27 l of propylene and the polymerization was carried out at a temperature of 105° C.

This gave 4.3 kg of polypropylene wax, corresponding to a catalyst activity of 270 kg of PP wax/mmol of zirconium/hour.

| | |
|---|---|
| Dropping point/softening point (ring/ball): | 163° C. |
| Melting point (DSC) | 160° C. |
| Heat of fusion (DSC) ΔH | 101 J/g |
| Melt viscosity (170° C.) | 8,300 mPas. |
| No unsaturated chain ends. | |

### Example 4

The procedure of example 1 was repeated using rac-ethanediylbis(2-methyl-4-phenylindenyl)zirconium dichloride as catalyst.

This gave 6.0 kg of polypropylene wax, corresponding to a catalyst activity of 354 kg of PP wax/mmol of zirconium/hour.

| | |
|---|---|
| Dropping point/softening point (ring/ball) | 161° C. |
| Melting point (DSC) | 158° C. |
| Heat of fusion (DSC) ΔH | 121 J/g |
| Melt viscosity (170° C.) | 189 mPas. |
| No unsaturated chain ends. | |

### Example 5

The procedure of example 4 was repeated with the vessel being pressurized with only 0.5 bar of hydrogen.

This gave 5.2 kg of polypropylene wax, corresponding to a catalyst activity of 311 kg of PP wax/mmol of zirconium/hour.

| | |
|---|---|
| Dropping point/softening point (ring/ball) | 162° C. |
| Melting point (DSC) | 158° C. |
| Heat of fusion (DSC) ΔH | 98 J/g |
| Melt viscosity (170° C.) | 5,530 mPas. |
| No unsaturated chain ends. | |

### Example 6

The procedure of example 3 was repeated using rac-dimethylsilanediylbis-6-[2,5-dimethyl-3-(2′-methylphenyl)cyclopentadienyl[1,2-b]thiophene]zirconium dichloride as catalyst and with the vessel being pressurized with 0.4 bar of hydrogen.

This gave 3.9 kg of polypropylene wax, corresponding to a catalyst activity of 379 kg of PP wax/mmol of zirconium/hour.

| | |
|---|---|
| Softening point (ring/ball): | 165° C. |
| Melting point (DSC) | 161° C. |
| Heat of fusion (DSC) ΔH | 103 J/g |
| Melt viscosity (170° C.): | 2,440 mPas. |
| No unsaturated chain ends. | |

### Example 7

The procedure of example 1 was repeated using rac-dimethylsilanediylbis(2-methyl-4-indenylindenyl)zirconium dichloride as catalyst.

This gave 8.3 kg of polypropylene wax, corresponding to a catalyst activity of 560 kg of PP wax/mmol of zirconium/hour.

| | |
|---|---|
| Dropping point/softening point (ring/ball): | 163° C. |
| Melting point (DSC) | 159° C. |
| Heat of fusion (DSC) ΔH | 109 J/g |
| Melt viscosity (170° C.) | 750 mPas. |
| No unsaturated chain ends. | |

### Example 8, Comparative Example 1 (Micronization)

The wax from example 1 was milled on a fluidized-bed opposed jet mill AFG 100 from Hosokawa Alpine. As a comparison which is not according to the invention, an L-C® 502N polypropylene wax from Lion Chemical Co., Ltd which had a softening point of 151° C. and a melt viscosity of 210 mPa·s/170° C. and had been prepared by thermal degradation was milled under analogous conditions. The results are compared in table 1. They show that a micronizate having a comparably fine particle size d50 but a significantly higher throughput could be obtained by means of the wax from example 1.

| | Milling | | | |
|---|---|---|---|---|
| | pressure | Classifier speed | Throughput | d50*) |
| | bar | rpm | g/h | μm |
| Example 8 | 6.5 | 10 500 | 950 | 7.8 |
| Comparative | 7.0 | 11 000 | 390 | 7.7 |
| example 1 | | | | |

*)measured by the laser light scattering method using an instrument from Malvern.

### Example 9 and Comparative Example 2 (Use in a Printing Ink Formulation)

The micronized waxes from example 8 and comparative example 1 were incorporated in an amount of 1.5% by weight into an offset ink (Novaboard cyan 4 C 86, K+E Druckfarben) by intensive stirring using a high-speed stirrer. A test print was produced (multipurpose test print machine system from Dr. Dürner) on Phoenomatt 115 g/m² paper (Scheufelen GmbH+Co KG) and the abrasion behavior was examined on an abrasion testing apparatus (abrasion tester from Quartant) at an abrasion load of 48 g/cm² and an abrasion rate of 15 cm/sec. The intensity of the ink transferred to the test sheet was assessed (color difference in accordance with DIN 6174, measured using Hunterlab D 25-2, Hunter). The results presented in the following table show that the wax according to the invention is significantly superior to the comparison in terms of color difference and thus abrasion resistance.

Color difference

| | 100 strokes | 200 strokes |
|---|---|---|
| Comparison without wax | 14.4 | 15.9 |
| Example 9 | 1.5 | 1.8 |
| Comparative example 2 | 2.5 | 3.1 |

### Example 10, Comparative Example 3 (Use for Dispersion of Pigments)

To produce a pigment masterbatch, a mixture of 30% by weight of the wax described in example 4, 40% by weight of the pigment C.I. Pigment Blue 15:1 (C.I. No. 74160 Heucoblau® 515303) and 30% by weight of polypropylene PP HG 235 J (Borealis) was mixed at room temperature in a Henschel FM 10 mixer for 5 minutes at a stirrer speed of 1000 rpm. The mixture was subsequently processed in a corotating twin-screw extruder to produce the masterbatch.

To assess the dispersing effectiveness, the pressure filter value was measured in accordance with the standard DIN EN 13009-5. The lower this value, the better the distribution of the pigment in the polyolefin matrix. In the present case, a measured value of 12.8 bar/g was obtained.

The polypropylene wax grade L-C® 502N from Lion Chemical Co., Ltd which had a softening point of 151° C. and a melt viscosity of 210 mPa·s/170° C. and had been prepared by thermal degradation, which was used according to example 9 in place of the inventive polypropylene wax from example 4, served as comparison. The measured pressure filter value was 17.9 bar/g.

### Example 11, Comparative Example 3 (Use in Hot Melt Adhesives)

Hot melt adhesives corresponding to the following table were produced. The components were melted together and mixed by stirring at 180° C. To test the cohesion, moldings were cast from the mixtures in accordance with DIN 53455 and their mechanical stability was tested in a tensile test. The polypropylene wax grade Licowax® PP 220 from Clariant Corporation which had a melt viscosity of 800 mPa·s/170° C., a DSC melting point of 154° C. and a heat of fusion of 72 J/g and had been prepared by Ziegler-Natta polymerization was used as comparison. Licocene PP 1602 TP is the trade name for a low-crystallinity metallocene propylene polymer from Clariant Corporation which has a ring/ball softening point of about 90° C.; Regalite® 1140 is the trade name for a hydrocarbon resin from Eastman Chem. Co.

The comparison shows that the mixture containing wax according to example 11 has a better cohesion and also a higher softening point and thus a higher heat resistance than the comparative mixture containing a polypropylene wax which is not according to the invention.

| | | Comparative | |
|---|---|---|---|
| | Example 11 | example 3 | |
| Licocene ® PP 1602 TP | 70 | 70 | parts by weight |
| Wax from example 7 | 5 | | parts by weight |
| Licowax ® PP 220 | | 5 | parts by weight |
| Regalite ® 1140 | 25 | 25 | parts by weight |
| Softening point | 160 | 153 | ° C. |
| Cohesion | 5.5 | 3.0 | N/mm² |

1. A polypropylene wax having comprising:
a) a dropping or softening point determined by the ring/ball method of greater than 155° C.,
b) heats of fusion greater than 80 J/g and
c) a DSC melting point of >155° C.

2. The polypropylene wax as claimed in claim 1 which has a molar mass distribution Mw/Mn in the range from 1.5 to 3.0.

3. The polypropylene wax as claimed in claim 1, wherein the viscosity measured in the melt at 170° C. is in the range from 20 to 30 000 mPa·s.

4. The polypropylene wax as claimed in claim 1, wherein the viscosity measured in the melt at 170° C. is in the range from 100 to 20 000 mPa·s.

5. The polypropylene wax as claimed in claim 1, wherein the content of unsaturated chain ends is less than 10%.

6. The polypropylene wax as claimed in claim 1, wherein the wax has been is chemically modified by introduction of polar, groups.

7. The polypropylene wax as claimed in claim 1, wherein wax is prepared by direct polymerization of propylene by means of metallocene catalysts.

8. A process for preparing a polypropylene wax comprising:
a) a dropping or softening point determined by the ring/ball method of greater than 155° C.,
b) a DSC melting point greater than 155° C.,
c) heats of fusion greater than 80 J/g and
d) a content of unsaturated chain ends of less than 10% comprising the steps of reacting propylene with at least one metallocene compound at temperatures in the range from 40 to 140° C., and an olefin in the presence of a cocatalyst, wherein the partial pressure is in the range from 1 to 50 bar.

9. The process as claimed in claim 8, wherein the at least one metallocene compound of the formula (Ia), (Ib) or (Ic) wherein M¹ is zirconium, titanium, hafnium, vanadium, niobium, tantalum, chromium, molybdenum or tungsten, 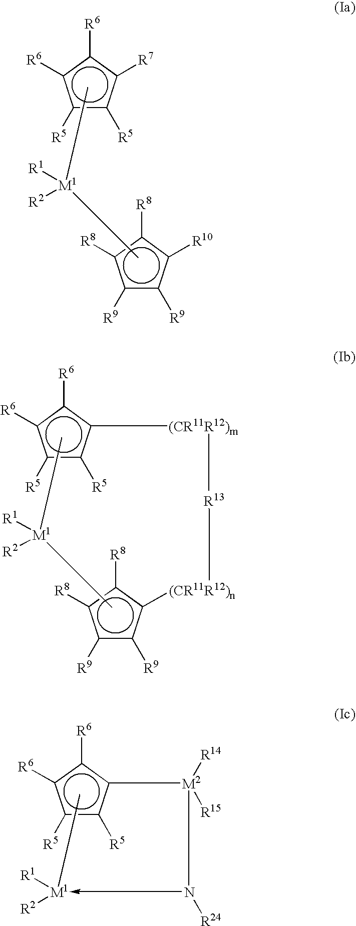
wherein
R¹ and R² are identical or different and are each a hydrogen atom, a C₁₋C₁₀-alkyl group, a C₁-C₁₀-alkoxy group, a C₆-C₁₀-aryl group, a C₆C₁₀-aryloxy group, a C₂-C₁₀-alkenyl group, a C₇-C₄₀-arylalkyl group, a C₇-C₄₀-alkylaryl group, a C₈-C₄₀-arylalkenyl group or a halogen atom,
R⁵, R⁶, R⁷, R⁸, R⁹ and R¹⁰ are identical or different and are each a hydrogen atom, a halogen atom, a C₁-C₁₀-alkyl group, a C₆-C₁₀-aryl group, a C₁-C₁₀-alkoxy group, an —NR¹⁶₂, —SR¹⁶, —OSiR¹⁶₃, —SiR¹⁶₃ or —PR¹⁶₂ radical, where R¹⁶ is a C₁-C₁₀-alkyl group or C₆-C₁₀-aryl group or in the case of Si— or P-containing radicals may optionally be a halogen atom or two adjacent radicals R⁵, R⁶, R⁷, R⁸, R⁹ or R¹⁰ together with the carbon atoms connecting them form a ring,
R¹³ is 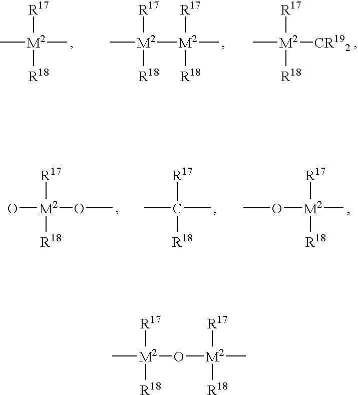
═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, wherein R¹⁷, R¹⁸ and R¹⁹ are identical or different and are each a hydrogen atom, a halogen atom, a C₁-C₃₀-alkyl group, a C₁-C₁₀-fluoroalkyl group, a C₆-C₁₀-fluoroaryl group, a C₆-C₁₀-aryl group, a C₁-C₁₀-alkoxy group, a C₂-C₁₀-alkenyl group, a C₇-C₄₀-aralkyl group, a C₈-C₄₀-arylalkenyl group or a C₇-C₄₀-alkylaryl group or R¹⁷ and R¹⁸ or R¹⁷ and R¹⁹ in each case together with the atoms connecting them form a ring, where R²⁴ has the meaning of R¹⁷,
M² is silicon, germanium or tin and
R¹³ is ═CR¹⁷R¹⁸, ═SiR¹⁷R¹⁸, ═GeR¹⁷R¹⁸, —O—, —S—, ═SO, ═PR or ═P(O)R¹⁷,
R¹¹ and R¹² are identical or different and have the meaning as R¹⁷,
m and n are identical or different and are each zero, 1 or 2 and m plus n is zero, 1 or 2,
and
R¹⁴ and R¹⁵ have the meanings of R¹⁷ and R¹⁸.

10. The process as claimed in claim 8, wherein the at least one metallocene compound is compound of the formula (2) 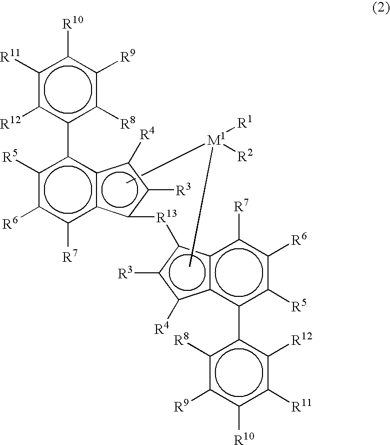
wherein M¹ is zirconium, titanium, hafnium, vanadium, niobium, tantalum, chromium, molybdenum or tungsten,
R¹ and R² are identical or different and are each a hydrogen atom, a C₁₋C₁₀-alkyl group, a C₁-C₁₀-alkoxy group, a C₆-C₁₀-aryl group, a C₆-C₁₀-aryloxy group, a C₂-C₁₀-alkenyl group, a C₇-C₄₀-arylalkyl group, a C₇-C₄₀-alkylaryl group, a C₈-C₄₀-arylalkenyl group or a halogen atom,
and
R³ to R¹² are identical or different and are each a hydrogen atom, a halogen atom, a C₁-C₁₀-alkyl group, optionally be halogenated, a C₆-C₁₀-aryl group, an —NR¹⁶₂, —SR¹⁶, —SiR¹⁶₃ or —PR¹⁶₂ radical, where R¹⁶ is a halogen atom, a C₁-C₁₀-alkyl group or a C₆₋C₁₀-aryl group,
where the adjacent radicals R⁴ to R¹² together with the atoms connecting them may form an aromatic or aliphatic ring.

11. The process as claimed in claim 8, wherein a compound of the formula (3) 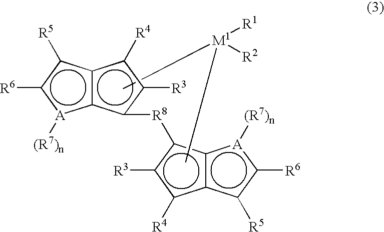
wherein
M¹ is a metal of group 4, 5 or 6 of the Periodic Table and A is an element of group 14, 15 or 16 of the Periodic Table,
n is 0, 1 or 2, with the proviso that n is 0 when A is an element of group 16 of the Periodic Table, n is 1 when A is an element of group 15 of the Periodic Table and n is 1 or 2 when A is an element of group 14 of the Periodic Table,
R¹ and R² are identical or different and are each a hydrogen atom, a C₁₋C₁₀-alkyl group, a C₁-C₁₀-alkoxy group, a C₆-C₁₀-aryl group, a C₆-C₁₀-aryloxy group, a C₂-C₁₀-alkenyl group, a C₇-C₄₀-arylalkyl group, a C₇-C₄₀-alkylaryl group, a C₈-C₄₀-arylalkenyl group or a halogen atom,
R³ to R⁷ are identical or different and are each a hydrogen atom, a halogen atom, a C₁-C₁₀-alkyl group, optionally halogenated, a C₆-C₁₀-aryl group, a C₇-C₁₀ alkylaryl group or a C₇-C₁₀ arylalkyl group and
R⁸ is 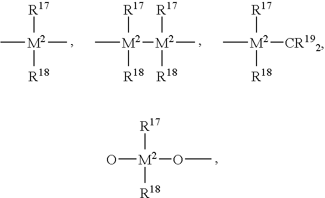
wherein R¹⁷, R¹⁸ and R¹⁹ are identical or different and are each a hydrogen atom, a halogen atom, a C₁-C₃₀-alkyl group, a C₁-C₁₀-fluoroalkyl group, a C₆-C₁₀-fluoroaryl group, a C₆-C₁₀-aryl group, a C₁-C₁₀-alkoxy group, a C₂-C₁₀-alkenyl group, a C₇-C₄₀-aralkyl group, a C₈-C₄₀-arylalkenyl group or a C₇-C₄₀-alkylaryl group or R¹⁷ and R¹⁸ or R¹⁷ and R¹⁹ in each case together with the atoms connecting them form a ring.

12. The process as claimed in claim 9, wherein M1 is zirconium.

13. The process as claimed in claim 8, wherein the cocatalyst is an organoaluminum compound or a mixture thereof.

14. The process as claimed in claim 8, wherein the organoaluminum compounds or mixtures thereof are added to the reaction mixture.

15. The process as claimed in claim 8, wherein the process further comprises a catalyst and wherein the catalyst and the cocatalyst are added in solution or in suspension to the reaction mixture.

16. The process as claimed in claim 8, further comprising the step of modifying the polypropylene wax by introduction of polar, and, optionally, oxygen-containing, functions.

17. The process as claimed in claim 16, wherein the modifying step is carried out by free-radical grafting reaction with polar monomers.

18. A dispersant for pigments comprising a polypropylene wax as claimed in claim 1.

19. An additive for printing inks and surface coatings comprising a polypropylene wax as claimed in claim 1.

20. A photo toner comprising a polypropylene wax as claimed in claim 1.

21. A lubricant or mold release agent for plastics processing comprising a polypropylene wax as claimed in claim 1.

22. An aqueous dispersion comprising a polypropylene wax as claimed in claim 6.

23. A bonding agent or compatibilizer for plastic compounds comprising a polypropylene wax as claimed in claim 6.

24. A formulation component for hot melt compositions comprising a polypropylene wax as claimed in claim 1.

25. The polypropylene wax as claimed in claim 1, wherein the wax is chemically modified by introduction of polar, oxygen-containing groups.

26. The process as claimed in claim 9, wherein R²⁴ is methyl, tert-butyl or cyclohexyl.

27. The process as claimed in claim 9, wherein R¹ and R² are identical or different and are each a hydrogen atom, a C₁-C₃-alkyl group, a C₁-C₃-alkoxy group, a C₆-C₈-aryl group, a C₆-C₈-aryloxy group, a C₂-C₄-alkenyl group, a C₇-C₁₀-arylalkyl group, a C₇-C₁₂-alkylaryl group, a C₈-C₁₂-arylalkenyl group or a chlorine atom.

28. The process as claimed in claim 9, wherein R¹ and R² are methyl.

29. The process as claimed in claim 9, wherein R¹ and R² are chlorine.

30. The process as claimed in claim 10, wherein R¹ and R² are identical or different and are each a hydrogen atom, a C₁-C₃-alkyl group, a C₁-C₃-alkoxy group, a C₆-C₈-aryl group, a C₆-C₈-aryloxy group, a C₂-C₄-alkenyl group, a C₇-C₁₀-arylalkyl group, a C₇-C₁₂-alkylaryl group, a C₈-C₁₂-arylalkenyl group or a chlorine atom.

31. The process as claimed in claim 10, wherein R¹ and R²are methyl.

32. The process as claimed in claim 10, wherein R¹ and R² are chlorine.

33. The process as claimed in claim 11, wherein R¹ and R² are identical or different and are each a hydrogen atom, a C₁-C₃-alkyl group, a C₁-C₃-alkoxy group, a C₆-C₈-aryl group, a C₆-C₈-aryloxy group, a C₂-C₄-alkenyl group, a C₇-C₁₀-arylalkyl group, a C₇-C₁₂-alkylaryl group, a C₈-C₁₂-arylalkenyl group or a chlorine atom.

34. The process as claimed in claim 11, wherein R¹ and R²are methyl.

35. The process as claimed in claim 11, wherein R¹ and R² are chlorine.

36. The process as claimed in claim 10, wherein M1 is zirconium.

37. The process as claimed in claim 11, wherein M1 is zirconium.

38. The process as claimed in claim 13, wherein the organoaluminum compound is an aluminoxane or aluminum-free system selected from the group consisting of R²⁰ₓNH₄₋ₓBR²¹₄, R²⁰ₓPH₄₋ₓBR²¹₄, R²⁰₃CBR²¹₄ and BR²¹₃, where x is from 1 to 4, the radicals R²⁰ are identical or different and are each C₁-C₁₀-alkyl or C₆-C₁₈-aryl or two radicals R²⁰ together with the atom connecting them form a ring and the radicals R²¹ are identical or different and are each a substituted or unsubstituted C₆-C₁₈-aryl radical.
